(19) United States
(12) Patent Application Publication
(10) Pub. No.: US 2015/0120491 A1
(43) Pub. Date: Apr. 30, 2015

(54) METHOD OF SENDING A PRINTED GROUP GREETING CARD

(71) Applicant: Anil Bisht, Bangalore (IN)

(72) Inventor: Anil Bisht, Bangalore (IN)

(21) Appl. No.: 14/375,202

(22) PCT Filed: Sep. 10, 2012
(86) PCT No.: PCT/IN2012/000603

§ 371 Date: Jul. 29, 2014

(30) Foreign Application Priority Data
Jul. 19, 2012 (IN) 2943/CHE/2012

(51) Int. Cl. G06Q 30/06; G06K 15/02; G06Q 50/32

(52) U.S. Cl. CPC G06Q 30/0621; G06Q 50/32; G06K 15/02
USPC 705/26.5

(57) ABSTRACT

The various embodiments herein provide a method for sending a printed group greeting card to a recipient on an occasion. A user registers with a greeting card portal and selects a desired greeting card template. The user customizes the greeting card based on a requirement. The user sends invitations and notifications to several invitees for writing the messages to the recipient based on an association. The invitees write the messages in the greeting card. The user sets a start time and an end time for allowing the invitees to write the messages on the greeting card within the time period. The user finalizes the content of the greeting card. After finalizing, the portal delivers the printed group greeting card to the intended recipient.

### RELATED APPLICATION

The present application is a national phase application of the International Application PCT/IN2012/000603 filed Sep. 10, 2012, which claims the priority of the Indian Provisional Patent Application No. 2943/CHF/2012 filed on Jul. 19, 2012, the entire contents of which are incorporated herein by the way of reference.

### BACKGROUND

1. Technical Field

The embodiments herein generally relate to an online portal for sending the greetings and particularly relates to a method for sending a group greeting card to a recipient. The embodiments herein more particularly relates to a method for sending a printed collective group greeting card from a group of friends or known persons to a recipient on an occasion.

2. Description of the Related Art

The greetings cards already exist for several years. People use the greeting card for sharing their joy with their known persons. The greeting card shares an expression of love, faith, trust, happiness etc from a sender to a recipient. Generally the greeting cards are sent on a special occasion such as birthdays, festivals, anniversaries, graduation, etc. The greeting card is a physical card containing a message form a sender and is either directly given or posted to the recipient. The currently available greeting cards have evolved to be of different types such as musical greeting cards, wooden greeting cards, online greeting cards etc.

With the provision of online greeting card, now a sender is able to send a custom designed electronic greeting card to a recipient at any time. The sender even sets a time and a date of delivering the greeting card to the recipient which eliminates the possibility of the sender from forgetting to send a greeting card to a recipient on a special occasion. Using the same methodology, many web portals have come up with an offer for sending a greeting card not only from a single user but also from a group to a single recipient. These web portals have their own drawbacks which are discussed here with other prior arts.

One of the existing prior arts provides a method to send an online greeting card to a single recipient. A sender registers with the website and provides the recipient details. Next the sender selects an online greeting card from the catalogue and provides the contact details of the people who know the recipient. A specific invitation is sent to the people for writing the greeting messages for the recipient. The contact details are the E-Mail ID of the people, which the sender enters individually in the portal. The process of providing E-Mail ID is time consuming and the sender may even enter a wrong E-Mail ID in the tendency of filling the form in a hurry, when the number of contact persons is more.

Another prior art provides a method for sending a group greeting card to a recipient. The method comprises inviting known people by a sender. Here the sender does not provide the individual E-Mail ID but imports the contacts from his/her social network sites. This prior art does not discuss about collecting an amount from all the invited people for a gift. Also an online greeting card is sent to the recipient and not a printed greeting card. A PDF copy of the greeting card is also sent to the recipient.

The above mentioned and other prior arts do not discuss about inviting friends and providing notifications through SMS to the mobile phones. Also only an online greeting card is sent to the recipient instead of a physical printed card. Further the prior arts do not discuss a customizing process of an online greeting card and printing the online greeting card in a flip book manner with many pages.

Hence there is need for a method of sending an online greeting card in a physical printed form to a recipient. Further, there is a need of inviting the people from a social network, E-Mail hosting portals and SMS means to avoid a loss of time and to prevent entering a wrong contact detail. Still further, there is a need for sending a printed greeting card to a recipient, when only a mobile number or e-mail address or a social networking identity of a recipient is known. Yet there is a need for a method for collecting an amount for sending a collective group greeting card to the recipient from the community/group.

The abovementioned shortcomings, disadvantages and problems are addressed herein and which will be understood by reading and studying the following specification.

### OBJECTS OF THE EMBODIMENTS

The primary object of the embodiments herein is to provide a method for sending a printed group greeting card to an intended recipient on an occasion.

Another object of the embodiments herein is to provide a method for inviting people and accumulating funds for sending a collective group greeting card to a recipient on an occasion.

Yet another object of the embodiments herein is to provide a printed group greeting card with a custom design or in a desired manner for a recipient on an occasion.

These and other objects and advantages of the present invention will become readily apparent from the following detailed description taken in conjunction with the accompanying drawings.

These and other objects and advantages of the embodiments herein will become readily apparent from the following detailed description taken in conjunction with the accompanying drawings.

### SUMMARY

The various embodiments herein provide a method for sending a printed group greeting card to a recipient on an occasion. The method comprises registering a user with a card printing portal, creating a greeting card template by the user for sending a printed group greeting card on an occasion to a recipient in the card printing portal. The method further comprises customizing a group greeting card by the user based on a requirement, inviting a plurality of invitees by the user for entering a greeting message in the customized group greeting card and for writing the messages in the customized group greeting card by sending an electronic notification. The electronic notification includes a universal resource locator (URL) associated with a web page for writing a greeting message and uploading an image in the group greeting card to be sent to the recipient. The method further comprises setting a start time and an end time by the user for allowing the plurality of invitees to write the messages on the customized group greeting card and for uploading the images, finalizing a content of the group greeting card to be sent to the recipient based on the received greeting messages and images from the plurality of the recipients after an elapse of the end time, printing a group greeting card to be sent to the recipient based on the finalized content and delivering the printed physical group greeting card to the recipient. The finalized content includes the written messages and the uploaded images.

According to an embodiment herein, the registered user is an administrator. The administrator controls a final content of the greeting card, manages the plurality of invitees and finalizes a design of the printed group greeting card.

According to an embodiment herein, the greeting messages from the plurality of the invitees include at-least one of a text message, an audio file, a video file, a multimedia file and a picture.

According to an embodiment herein, the plurality of invitees are invited for writing the messages on the group greeting card to be sent to the recipient by sending an electronic notifications. The electronic notification comprises sending an E-Mails and short messages (SMS) on the mobile phones of the plurality of invitees. The pluralities of the invitees are invited by importing the contacts from the social networking sites and the E-Mail hosting websites.

According to an embodiment herein, the printed group greeting card delivered to the recipient is in a Zigzag type folded form. Each fold of the group greeting card includes at-least one message.

According to an embodiment herein, the Zigzag type folded printed group greeting card delivered to the recipient comprises any number of folds. The number of folds in the printed group greeting card depends on the number of invites and the number of messages received from the plurality of invitees to be printed on the group greeting card.

According to an embodiment herein, the method for sending a printed group greeting card to a recipient further comprises allowing a third party vendor to collaborate with the website for printing the group greeting card.

According to an embodiment herein, the method for sending a printed group greeting card to a recipient further comprises forwarding an electronic notification to the plurality of invitees by the user for writing the greeting messages and uploading the images in the group greeting card.

According to an embodiment herein, customizing a group greeting card comprises customizing the group greeting card with respect to a size, a font, a color and a design.

According to an embodiment herein, the method for sending a printed group greeting card to a recipient is a paid version.

According to an embodiment herein, the method for sending a printed group greeting card to a recipient further comprises collecting a financial contribution from the plurality of invitees for printing and sending the printed group greeting card to the recipient.

According to an embodiment herein, the financial contribution collected from the plurality of the invitees for printing and sending the printed group greeting card to the recipient is same.

According to an embodiment herein, the financial contribution collected from the plurality of the invitees for printing and sending the printed group greeting card to the recipient is varied.

According to an embodiment herein, the financial contribution collected from the plurality of the invitees for printing and sending the printed group greeting card to the recipient is an amount desired by an invitee.

According to an embodiment herein, the method for sending a printed group greeting card to a recipient further comprises forwarding electronic reminders to the plurality of invitees before a closing of the end time to write the messages and to upload the images.

According to an embodiment herein, the end time is estimated by the portal based on a type of delivery and a printing time. The end time is finalized by the administrator and a finalized end time is set not later than an estimated end time.

According to an embodiment herein, the method for sending a printed group greeting card to a recipient further comprises requesting a user to furnish an address of a recipient to the portal, when the address of the recipient is known to the user. When the address of the recipient is not known, the portal requests the user to provide a mobile number or e-mail address or a social networking identity of the recipient. When the user furnishes an e-mail ID or a social network ID or mobile number of the recipient, the portal sends a request message to the recipient through the given e-mail ID or a social network ID or mobile number to confirm whether the recipient is willing to receive a printed group greeting card from the user and asks the recipient to furnish his postal address or mailing address for receiving the printed group greeting card. When the recipient confirms the willingness to receive the printed group greeting card and furnishes his postal address or mailing address, the received postal address or mailing address of the recipient is stored in the portal. The portal stores the given postal address or mailing address of the recipient without disclosing the same to the user. The address stored in the database of the card printing portal is never disclosed to the user or friends without the permission of the recipient. This address is then printed on the greeting card for delivery.

According to an embodiment herein, the portal stores the received address of the recipient and the received address of the recipient is not shared with the registered user unless the recipient permits a sharing of the address with the registered user.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiments herein and the accompanying drawings in which:

FIG. 1 illustrates a flow chart for a method of sending a printed group greeting card to an intended recipient, according to an embodiment herein.

FIG. 2 illustrates a block diagram of a system for sending a printed group greeting card to an intended recipient, according to an embodiment herein.

FIG. 3 illustrates a flow chart for a method of sending a group greeting card to a residential/postal/mailing address of a recipient, when the residential address or a postal address or a mailing address of a recipient is not known to a user, according to an embodiment herein.

FIG. 4 illustrates a side perspective view of the printed group greeting card, according to an embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the present invention provide a method for sending a printed group greeting card to a recipient on an occasion. The method comprises registering a user with a card printing portal, creating a greeting card template by the user for sending a printed group greeting card on an occasion to a recipient in the card printing portal. The method further comprises customizing a group greeting card by the user based on a requirement, inviting a plurality of invitees by the user for entering a greeting message in the customized group greeting card and for writing the messages in the customized group greeting card by sending an electronic notification. The electronic notification includes a universal resource locator (URL) associated with a web page for writing a greeting message and uploading an image in the group greeting card to be sent to the recipient. The method further comprises setting a start time and an end time by the user for allowing the plurality of invitees to write the messages on the customized group greeting card and for uploading the images, finalizing a content of the group greeting card to be sent to the recipient based on the received greeting messages and images from the plurality of the recipients after an elapse of the end time, printing a group greeting card to be sent to the recipient based on the finalized content and delivering the printed physical group greeting card to the recipient. The finalized content includes the written messages and the uploaded images.

According to an embodiment herein, the registered user is an administrator. The administrator controls a final content of the greeting card, manages the plurality of invitees and finalizes a design of the printed group greeting card.

According to an embodiment herein, the greeting messages from the plurality of the invitees include at-least one of a text message, an audio file, a video file, a multimedia file and a picture.

According to an embodiment herein, the plurality of invitees are invited for writing the messages on the group greeting card to be sent to the recipient by sending an electronic notifications. The electronic notification comprises sending an E-Mails or short messages (SMS) on the mobile phones of the plurality of invitees. The pluralities of the invitees are invited by importing the contacts from the social networking sites and the E-Mail hosting websites.

According to an embodiment herein, the printed group greeting card delivered to the recipient is in a Zigzag type folded form. Each fold of the group greeting card includes at-least one message.

According to an embodiment herein, the Zigzag type folded printed group greeting card delivered to the recipient comprises any number of folds. The number of folds in the printed group greeting card depends on the number of invites and the number of messages received from the plurality of invitees to be printed on the group greeting card.

According to an embodiment herein, the method for sending a printed group greeting card to a recipient further comprises allowing a third party vendor to collaborate with the website for printing the group greeting card.

According to an embodiment herein, the method for sending a printed group greeting card to a recipient further comprises forwarding an electronic notification to the plurality of invitees by the user for writing the greeting messages and uploading the images in the group greeting card.

According to an embodiment herein, customizing a group greeting card comprises customizing the group greeting card with respect to a size, a font, a color and a design.

According to an embodiment herein, the method for sending a printed group greeting card to a recipient is a paid version.

According to an embodiment herein, the method for sending a printed group greeting card to a recipient further comprises collecting a financial contribution from the plurality of invitees for printing and sending the printed group greeting card to the recipient.

According to an embodiment herein, the financial contribution collected from the plurality of the invitees for printing and sending the printed group greeting card to the recipient is same.

According to an embodiment herein, the financial contribution collected from the plurality of the invitees for printing and sending the printed group greeting card to the recipient is varied.

According to an embodiment herein, the financial contribution collected from the plurality of the invitees for printing and sending the printed group greeting card to the recipient is an amount desired by an invitee.

According to an embodiment herein, the method for sending a printed group greeting card to a recipient further comprises forwarding electronic reminders to the plurality of invitees before a closing of the end time to write the messages and to upload the images.

According to an embodiment herein, the end time is estimated by the portal based on a type of delivery and a printing time. The end time is finalized by the administrator and a finalized end time is set not later than an estimated end time.

According to an embodiment herein, the method for sending a printed group greeting card to a recipient further comprises requesting a user to furnish an address of a recipient to the portal, when the address of the recipient is known to the user. When the address of the recipient is not known, the portal requests the user to provide a mobile number or e-mail address or a social networking identity of the recipient. When the user furnishes an e-mail ID or a social network ID or mobile number of the recipient, the portal sends a request message to the recipient through the given e-mail ID or a social network ID or mobile number to confirm whether the recipient is willing to receive a printed group greeting card from the user and asks the recipient to furnish his postal address or mailing address for receiving the printed group greeting card. When the recipient confirms the willingness to receive the printed group greeting card and furnishes his postal address or mailing address, the received postal address or mailing address of the recipient is stored in the portal. The portal stores the given postal address or mailing address of the recipient without disclosing the same to the user. The address stored in the database of the card printing portal is never disclosed to the user or friends without the permission of the recipient. This address is then printed on the greeting card for delivery.

According to an embodiment herein, the portal stores the received address of the recipient and the received address of the recipient is not shared with the registered user unless the recipient permits a sharing of the address with the registered user.

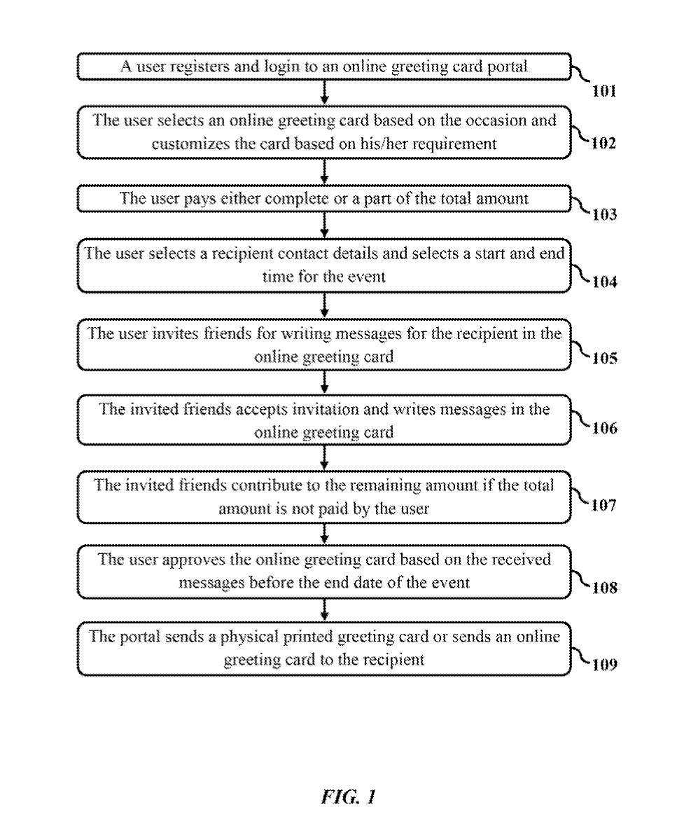

FIG. 1 illustrates a flow chart for a method of sending a printed group greeting card to an intended recipient, according to an embodiment herein. The terms “card printing portal” and “online greeting card portal” are used interchangeably in the document. A user opens the card printing portal from a computing device. The computing device is any one of a laptop, desktop, tablet, smart phones, PDAs etc., which is capable of providing an internet communication. The user registers with the card printing portal by providing the user credentials such as name, age, contact details, etc. The user is registered with the card printing portal. The registered user logs in the card printing portal (101). The registered user is the administrator for any event created by him/her. The registered user selects an online greeting card based on the occasion and customizes the card based on his/her requirement (102). The registered user selects a desired template, customizes a template or creates a completely new online greeting card based on the occasion. The online group greeting card is provided under paid categories. The user pays the amount of generating the printed group greeting card to the group greeting card portal either completely or partially (103). Then the user provides the contact details of a recipient such as mobile number or a residential address, or E-Mail ID or Social network address etc in the card printing portal. The user also selects a start time and a stop time for writing or uploading the greeting messages and the images in the online group greeting card to be sent to the recipient (104). Further the user invites a plurality of invitees for writing a respective message in the group greeting card. The invitations are sent to the invitees by importing the contacts from the social networking account or E-Mail hosting portals. The invitations are also sent as short message service (SMS) to the invitees through the mobile phones (105). The invitation comprises the details for the event, a start time, an end time, universal resource locator (URL) of a webpage and other details. The invitees accept and write the messages in the online group greeting card (106). The universal resource locator (URL) of the webpage remains open till the closing of the end time/period of the event. The invited friends contribute to the amount for sending the printed group greeting card, if the user has paid partial amount (107). The user receives a notification from the card printing portal for finalizing the messages provided by the invitees before or at the closing of the end time of the event. The user as an administrator, reviews the messages, edits an appropriate content and finalizes the messages which are to be printed on the greeting card (108). Once the user finalizes the messages provided by the invitees before or at the closing time or the end time of the event, the portal sends the finalized group greeting card to a printing press for printing in a user desired manner. The printing press prints the group greeting card and the portal posts the physical printed group greeting card to the intended recipient (109). The occasion includes birthday, festival, retirement, graduation etc.

According to an embodiment herein, the user invites the friends and known persons for contributing funds for sending a printed group greeting card. The invitation comprises the details of the event and as well as an option of non-mandatory individual participation for a financial contribution towards the total amount for the recipient. The user and the invitees contribute a respective desired amount towards the paid printed group greeting card for the recipient. The contributed amount is either an equal amount or unequal amount. The contributed amount is either collected in an online account provided by the card printing portal or is collected in the registered user's personal account. The card printing portal itself provides the facility of printing the online group greeting card in a desired manner. Alternately, the user selects the region where the recipient resides and a suitable vendor for ordering the printing of the online group greeting card is selected based on the region. The user completes the payment transactions through the online services or directly pays the vendor at the venue. The vendor delivers the printed group greeting card to the recipient at the specified date and time.

The portal asks the user to furnish the postal address or the mailing address of a recipient for sending a printed greeting card to the recipient, when the postal address or the mailing address of a recipient is known to the user. When the postal address or the mailing address of a recipient is not known to the user, the portal asks the user to furnish an E-mail ID (Gmail™, Yahoo Mail™, Hotmail™, etc) or a Social network IDs (Facebook™ ID, LinkedIn™ ID, Twitter™, Google+™ etc.) or a mobile number of the recipient. When the user furnishes an e-mail ID or a social network ID or mobile number of the recipient, the portal sends a request message to the recipient through the given e-mail ID or a social network ID or mobile number to confirm whether the recipient is willing to receive a printed group greeting card from the user and asks the recipient to furnish his postal address or mailing address for receiving the printed group greeting card. When the recipient confirms the willingness to receive the printed group greeting card and furnishes his postal address or mailing address, the received postal address or mailing address of the recipient is stored in the portal. The portal stores the given postal address or mailing address of the recipient without disclosing the same to the user. The address stored in the database of the card printing portal is never disclosed to the user or friends without the permission of the recipient. This address is then printed on the greeting card for delivery.

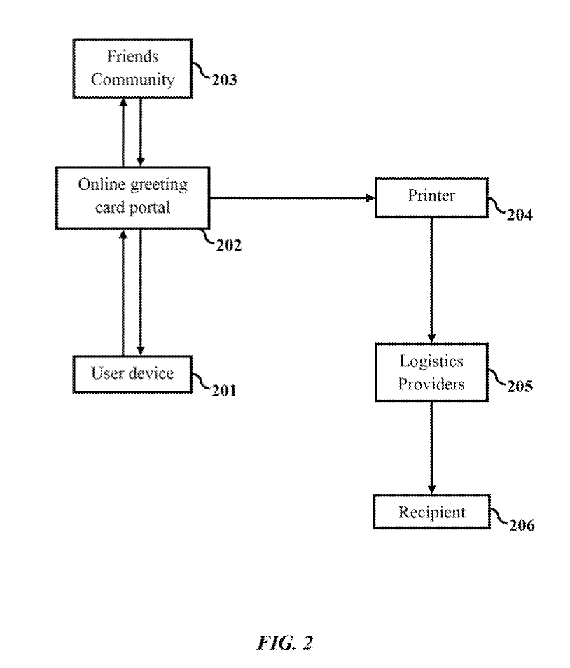

FIG. 2 illustrates a block diagram of a system, for sending a printed group greeting card to an intended recipient, according to an embodiment herein. A user selects a computing device such as computer, laptop, smart phone etc. hereby referred to as a user device 201. The user opens the card printing portal 202 in the user device 201 though an internet browser. The user provides the necessary details of the recipient and contact details of the invitees in the online greeting card portal 202. The invitees are the friends and other persons who are in association with the recipient. The invitees are defined to form a community of friends 203. Once all the messages are written in the group greeting card, the user finalizes the messages to be written in the group greeting card and the portal sends the finalized group greeting card to the printer 204 for printing the group greeting card. The printed group greeting card is delivered to the recipient 206 using a logistics provider. The greeting card portal engages a suitable logistics provider 205 such as but not limited to Postal services, Courier services etc to deliver the printed group greeting card to the recipient 206.

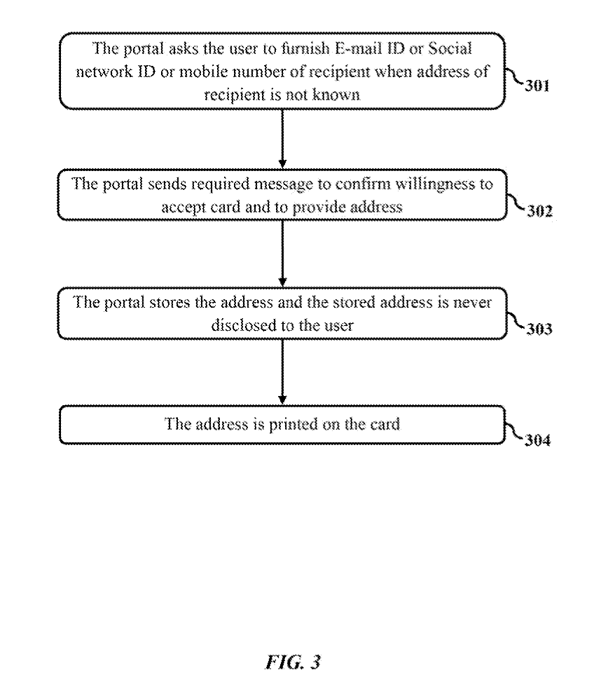

FIG. 3 illustrates a flow chart for a method of sending a group greeting card to a residential/postal/mailing address of a recipient, when the residential address or a postal address or a mailing address of a recipient is not known to a user, according to an embodiment herein. The portal asks the user to furnish the postal address or the mailing address of a recipient for sending a printed greeting card to the recipient, when the postal address or the mailing address of a recipient is known to the user. When the postal address or the mailing address of a recipient is not known to the user, the portal asks the user to furnish an E-mail ID (Gmail™, Yahoo Mail™, Hotmail™, etc) or a Social network IDs (Facebook™ ID, LinkedIn™ ID, Twitter™, Google+™, etc.) or a mobile number of the recipient (301). When the user furnishes an e-mail ID or a social network ID or mobile number of the recipient, the portal sends a request message to the recipient through the given e-mail ID or a social network ID or mobile number to confirm whether the recipient is willing to receive a printed group greeting card from the user and asks the recipient to furnish his postal address or mailing address for receiving the printed group greeting card (302). When the recipient confirms the willingness to receive the printed group greeting card and furnishes his postal address or mailing address, the received postal address or mailing address of the recipient is stored in the portal. The portal stores the given postal address or mailing address of the recipient without disclosing the same to the user. The address stored in the database of the card printing portal is never disclosed to the user or friends without the permission of the recipient (303). This address is then printed on the greeting card for delivery (304).

According to an embodiment herein, a cost of sending the printed group greeting card to the recipient depends on a delivery mechanism. The delivery mechanism depends on the type of vender or the number of days required for delivering the printed group greeting card. The user selects the option of delivery such as an express delivery, a special delivery or a normal delivery. In the express delivery mode, the group greeting card is delivered on the next day. In the special delivery mode, the group greeting card is delivered within few days to the recipient. In the normal deliver mode, the delivery of the group printed card takes few more days than the special delivery. Based on the type of delivery mechanism, a corresponding amount chart is displayed to the user. The user selects an affordable delivery mechanism based on the collected fund and the portal sends the printed group greeting card to the recipient.

According to an embodiment herein, a total amount required for sending a group greeting card to the recipient on an event is shown to the user. The total amount includes an amount for the designer card or paid card, printing cost, and delivery cost of the printing card. The user is able to access the portal or link to upload the messages and images, only when the total amount is received by the card printing portal.

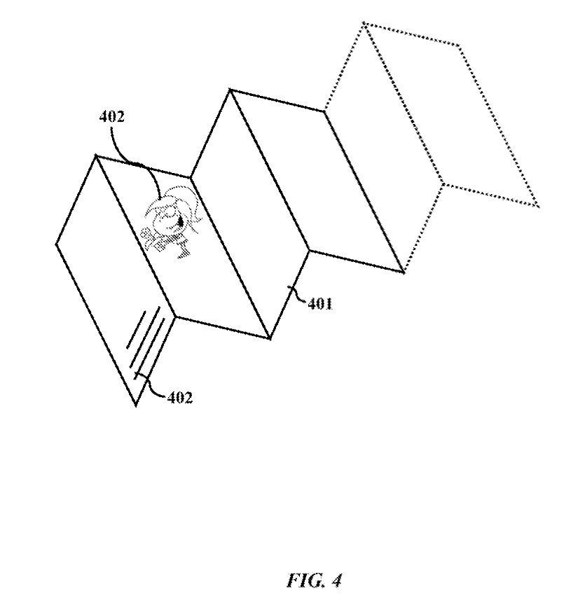

FIG. 4 illustrates a side perspective view of flip-flap shaped printed group greeting card, according to an embodiment herein. The design illustrated in the FIG. 4 is a flip-flap type or zigzag shaped card 401 comprising several folds. The flip-flap type card 401 has multiple folds. The number of folding is decided by the number of messages or the number of friends interested in writing message to the recipient. Also the card printing portal accommodates the messages of the group in the flip-flap type greeting card based on the number of foldings required by the user. Each page of the flip-flap type greeting card 401 comprises at-least one message of a friend. The straight lines 402 shown in the first folded page of the flip-flap type greeting card 401 displays a message written by a user or by an invited friend for the recipient. The image 403 displayed in the second folded page of the flip-flap type greeting card 401 shows a customized picture of a friend. The flip-flap type greeting card 401 is customizable to any design through the online card printing portal. Each page can have a message or picture/image or both.

According to an embodiment herein, the card printing portal allows the vendors to collaborate with the portal. The vendors are any one of a card printing vendor, card designing vendor, delivery vendor etc. The vendors from across the globe register themselves with the portal and expand their business. A certain amount of profit or agreement is signed between the vendor and the card printing portal. Even individual persons are allowed to design a greeting card and upload on the portal. The card printing portal also provides a business relationship between a user who needs a desired card design and the card design vendor or individual designer.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method for sending a printed group greeting card to a recipient on an occasion, the method comprising:
registering a user with a card printing portal;
creating a greeting card template by the user, for sending a printed group greeting card on an occasion to a recipient in the card printing portal;
customizing a group greeting card by the user based on a requirement;
inviting a plurality of invitees by the user for entering a greeting message in the customized group greeting card and for writing the greeting message in the customized group greeting card by sending an electronic notification, and wherein the electronic notification includes a universal resource locator associated with a web page for uploading a greeting message and an image to be put into the group greeting card to be sent to the recipient;
setting a start time and an end time by the user for allowing the plurality of invitees to write the greeting message on the customized group greeting card and for uploading the greeting messages and the images;
finalizing a content of the group greeting card to be sent to the recipient by the user based on the received greeting messages and images from the plurality of the recipients after an elapse of the end time;
printing a group greeting card to be sent to the recipient based on the finalized content, and wherein the finalized content includes the greeting messages and the images; and
delivering the printed physical group greeting card to the recipient.

2. The method according to claim 1, wherein the registered user is an administrator, and wherein the administrator controls a final content of the group greeting card, manages the plurality of invitees and finalizes a design of the group greeting card.

3. The method according to claim 1, wherein the greeting messages from the plurality of the invitees includes at-least one of a text message, an audio file, a video file, a multimedia file and a picture.

4. The method according to claim 1, wherein the plurality of invitees are invited for writing the greeting messages on the printed group greeting card to be sent to the recipient by sending messages through E-Mail or social networking sites or mobile phones.

5. The method according to claim 1, wherein the printed group greeting card delivered to the recipient is a Zigzag type folded card, and wherein each Zigzag type fold includes at-least one greeting message.

6. The method according to claim 1, wherein the Zigzag type folded printed group greeting card delivered to the recipient comprises any number of folds, and wherein the number of folds depends on the number of the greeting messages to be printed on the group greeting card.

7. The method according to claim 1 further comprises allowing a third party vendors to collaborate with the website for printing the group greeting card.

8. The method according to claim 1 further comprises forwarding an electronic notification to the plurality of invitees by the user for writing the greeting messages and uploading the images in the group greeting card

9. The method according to claim 1, wherein customizing a group greeting card comprises customizing the group greeting card with respect to a size, a font, a color and a design.

10. The method according to claim 1 further comprises providing a paid version of sending the printed group greeting card to the recipient through the card printing portal.

11. The method according to claim 10 further comprises collecting a financial contribution from the plurality of invitees for printing and sending the printed group greeting card to the recipient.

12. The method according to claim 11, wherein the financial contribution collected from the plurality of the invitees for printing and sending the printed group greeting card to the recipient is same.

13. The method according to claim 11, wherein the financial contribution collected from the plurality of the invitees for printing and sending the printed group greeting card to the recipient is varied.

14. The method according to claim 11, wherein the financial contribution collected from the plurality of the invitees for printing and sending the printed group greeting card to the recipient is an amount desired by an invitee.

15. The method according to claim 1, further comprises forwarding reminders to the plurality of invitees before the closing of the end time to write messages and upload images.

16. The method according to claim 1, wherein the end time will be estimated by the portal based on a type of delivery and a printing time and wherein the end time is finalized by the administrator and wherein a finalized end time is set not later than an estimated end time.

17. The method according to claim 1, wherein the card printing portal asks the user to furnish a postal address or a mailing address of a recipient for sending a group printed greeting card when the address of a recipient is known to the user.

18. The method according to claim 1, wherein the card printing portal asks the user to furnish a an e-mail ID of the recipient or a social network ID of the recipient or a mobile phone of the recipient, when the address of a recipient is not known to the user.

19. The method according to claim 1, wherein the card printing portal sends a request message to a recipient through an e-mail ID of the recipient or a social network ID of the recipient or a mobile phone of the recipient for confirming a willingness to receive the printed group greeting card from the user and furnishes the postal address or a mailing address of the recipient.

20. The method according to claim 1, wherein the card printing portal stores the postal address or the mailing address received from a recipient wherein the received address of the recipient is not shared with the registered user unless the recipient permits a sharing of the address with the registered user.
